(19) United States
(12) Patent Application Publication
(10) Pub. No.: US 2013/0104035 A1
(43) Pub. Date: Apr. 25, 2013

(54) GPS TRACKING SYSTEM AND METHOD EMPLOYING PUBLIC PORTAL PUBLISHING LOCATION DATA

(71) Applicants: Robert Wagner, Woodstock, IL (US); Vincent Lee, Houston, TX (US); Rob Phillips, Bartlesville, OK (US)

(72) Inventors: Robert Wagner, Woodstock, IL (US); Vincent Lee, Houston, TX (US); Rob Phillips, Bartlesville, OK (US)

(21) Appl. No.: 13/281,181

(22) Filed: Oct. 25, 2011

(51) Int. Cl. G06F 15/16; G06F 3/048; G06F 17/00

(52) U.S. Cl. 715/240; 709/203; 715/738; 715/234

(57) ABSTRACT

A GPS tracking device sends multiple real-time location coordinates to a database which is then published on a secured webpage containing a map and device location. The GPS tracking device owner can retrieve the publishing code or URL from the secured webpage and can then publish the portal in any public internet media outlet such as websites, internet 1Vs and mobile devices. With this method, the owner can share the real-time location of the GPS devices to the user being shared without security verification or software installation on the user's computer or mobile device. To share the location of the GPS tracking device, the owner needs only to embed a set of publishing codes on a webpage or share a web URL. This method is beneficial for anyone wanting to share real-time physical location. The user can access the shared location by viewing the published public portal without security verification.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Technical Field

The present invention relates generally to online systems and methods for reporting geolocation information. More particularly, the present embodiments relate to a GPS tracking system and method employing public portal publishing location data.

2. Background Information

Systems have been developed to collect and make available geolocation information. Geolocation information is data or other information which identifies a geographical location of a person or resource. The information can have various formats and precision and content. One well-known source of geolocation information is the Global Positioning System (GPS). Terrestrial devices receive transmissions from orbiting satellites of the GPS system and use information contained in the transmissions to determine their position. The determined position information typically includes latitude, longitude and elevation. Additional information that may be derived includes a heading and speed if the device is in motion.

Various apparatus have been developed for use by a user. These include stand-alone, handheld devices and software applications operable in conjunction with hardware devices such as smartphones to produce a GPS receiver. These devices may display geolocation data such as latitude and longitude. In addition, these devices may combine the geolocation data with map data to produce a graphical image showing a determined location on a map. Additionally, aerial view information may be available so that the device may combine the determined location on an aerial view of the surrounding region and even combine the map information, the aerial information and the determined location.

In addition to having the geolocation information available at a handheld device, other systems have been developed to convey that geolocation information to a remote location. For example, it is known to install tracking software on a remotely located computing device such as a hosting server. The tracking software communicates with client-side javascript files for display on a client device of maps with the geolocation information for a tracked device. Network functionality, such as the internet, permits the display to be updated.

These known systems for remote tracking have met commercial success, for example, for tracking fleet vehicles or delivery or service vehicles or personnel. However, some system operators object to the type of data and applications used by these known systems. Examples of potentially objectionable software components include PHP scripts and javascripts which may be difficult to control. System operators object to including such components on a computer or other device with web pages or other data of the operator. Malfunction or failure of the script hosted on the operator's may be attributed to the operator, injuring their brand or commercial reputation.

Accordingly, there is a need to provide a geolocation tracking system at a location which is remote from a tracked device which avoids use of objectionable software components such as javascript and PHP scripts. Additionally, there is a need to provide more reliable tracking of use of geolocation data so that such usage can be properly tracked and accounted for.

### BRIEF SUMMARY

By way of introduction only, the preferred embodiment described below provides a system and method in which a database receives multiple real-time location coordinates from a GPS tracking device. Location information for the GPS tracking device is then published on a secured webpage containing a map and the location of the device. The GPS tracking device owner can retrieve the publishing code or URL from the secured webpage and can then publish a portal with the information in any public internet media outlet such as websites, internet televisions and mobile devices. With this arrangement, the owner can share the real-time location of one or more GPS devices to the user without security verification or software installation on the user's computer or mobile device. To share the location of the GPS tracking device, the owner needs only to embed a set of publishing codes on a webpage or share a web URL. This method is beneficial for anyone wanting to share real-time physical location, such as transportation companies and mobile food trucks, or personal location, for people to follow or find them. The user can access the shared location by method of viewing the published public portal without security verification.

In a first aspect, the present disclosure relates to a method for providing location information. The method includes in one embodiment periodically receiving geolocation data for a mobile source at a server system and storing the geolocation data, for example in a database. The method further includes receiving a publishing request from an authorized user of the geolocation data to share location information for the mobile source. In response to the publishing request, the method includes communicating to the authorized user a publishing code for incorporation in any web page or a Universal Resource Locator (URL) for a web page, or both. The web page is to be displayed by the authorized user or another user in order to share with the authorized user or other user substantially real time location for the mobile source.

In a second aspect, the present disclosure relates to a geolocation server system. The system includes in one embodiment a data retrieval server which is configured to receive geolocation data over a network from one or more mobile sources. The system further includes a gateway server configured to communicate with a remote map data server and a database configured to store data including the received geolocation data and map data received from the map data server. The system further includes a user interface server configured to receive from an authorized user a request to share location information for a set of mobile sources of the one or more mobile sources. In response to the request, the user interface server is configured to share at least one of a publishing code for incorporation in a destination web page and a Universal Resource Locator (URL) for the destination web page. The destination web page is to be displayed on a display device of the authorized user or another user and includes a graphical location display for the set of mobile sources.

In a third aspect, the present disclosure relates to a global positioning system (GPS) tracking method which includes receiving at a data retrieval server GPS location data from a GPS device. The method further includes determining at a gateway server the physical address of the GPS device and storing the physical location at a database. The method further includes publishing the location data on a map interface and subsequently receiving an access inquiry from an authorized user. In response to a user request, the authorized user is provided with one or both of a public portal publishing code to insert on a web page designated by the authorized user or a Uniform Resource Locator (URL) to share with a web browser. Further, the method includes providing the location data on the map interface to be inserted in the web page or to be shared to the web browser.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a block diagram of a geolocation server system;

FIG. 2 is a screen shot of an exemplary web portal page provided to a user by the geolocation server system of FIG. 1;

FIG. 3 is a flow diagram of a method for providing location information;

FIG. 4 is a flow diagram of a method for providing location information;

FIG. 5 is a flow diagram of a method for providing location information;

FIG. 6 is a screen shot illustrating an exemplary web page provided to a non-authorized user by the geolocation server system of FIG. 1; and

FIG. 7 is a screen shot illustrating embedding of a publishing code in a website for use by a user.

### DETAILED DESCRIPTION OF THE DRAWINGS AND THE PRESENTLY PREFERRED EMBODIMENTS

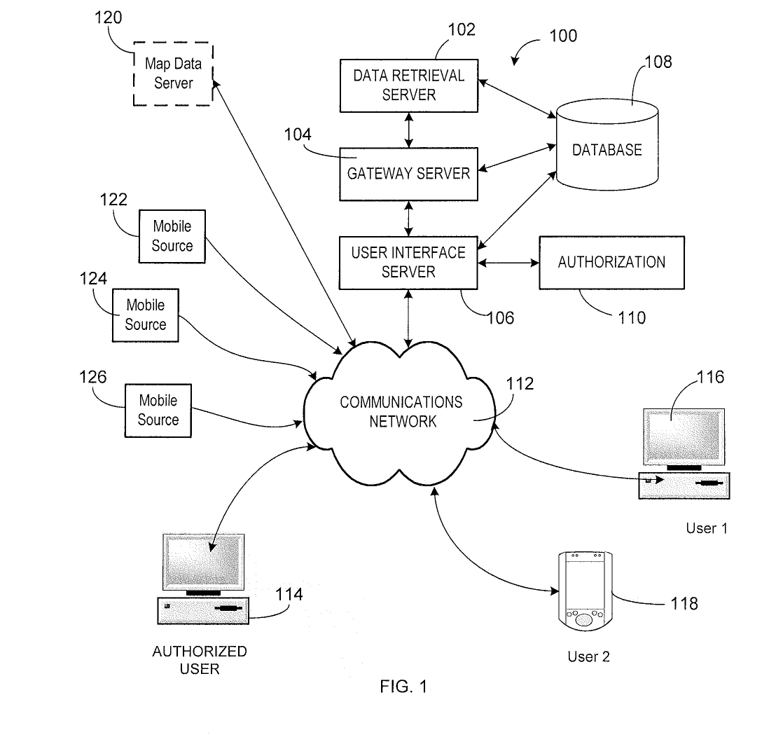

Referring now to the drawing, FIG. 1 is a block diagram of a geolocation server system 100. The geolocation server system 100 includes in the exemplary embodiment a data retrieval server 102, a gateway server 104, a user interface server 106, a database 108 and an authorization module 110. In other embodiments, additional components may be added to provide additional or different functionality or to improve efficiency to achieve other design goals. Moreover, the servers 102, 104, 106 may be combined into fewer devices where appropriate. Still further, the components of the geolocation server system 100 may be incorporated with other functional elements as part of a system that performs additional functions for additional customers, subscribers and clients.

Any suitable data processing system may be used to implement the servers 102, 104, 106. A typical data processing system suitable for the functions described herein generally includes one or more processors which operate in conjunction with data and instructions stored in a memory. The instructions generally include computer readable program code stored on a computer readable medium such as semiconductor memory and magnetic or optical disk. The database 108 is one example of such a memory device.

The database 108 stores data and instructions for access by the servers 102, 104, 106. The stored data may originate locally with one of the servers 102, 104, 106 or may originate elsewhere and be received by one of the servers 102, 104, 106. For example, in the embodiment of FIG. 1, data may originate at authorized user device 114, user device 116, user device 118, map data server 120, or mobile sources 122, 124, 126. Similarly, data may be communicated from any of the servers 102, 104, 106 to any of these external destinations. Any suitable data communication technique may be employed for communication among the illustrated components. A standardized data transfer protocol such as transfer control protocol/internet protocol (TCP/IP) may be used, as one example. Moreover, communication channels may include any combination of wireless or wire line data communication. Further, any suitable data storage apparatus may be used to implement the database 108.

Within the geolocation server system 100, the servers 102, 104, 106, database 108 and authorization module 110 may communicate together as required for operation of the system 100. Accordingly, the geolocation server system 100 may include one or more data buses and other communication facilities. Further, for communication with external components, the geolocation server system 100 includes an interface for communication with one or more networks such as network 112.

The authorization module 110 is configured to receive identification data from a user and to designate the user as an authorized user based on the received identification data. This designation may be conducted in any suitable manner, for example by comparing the identification data with a file of authorized users. The authorization module may be part of one of the servers 102, 104, 106 or may be implemented as a stand-alone data processing system with separate processor and memory as shown in FIG. 1.

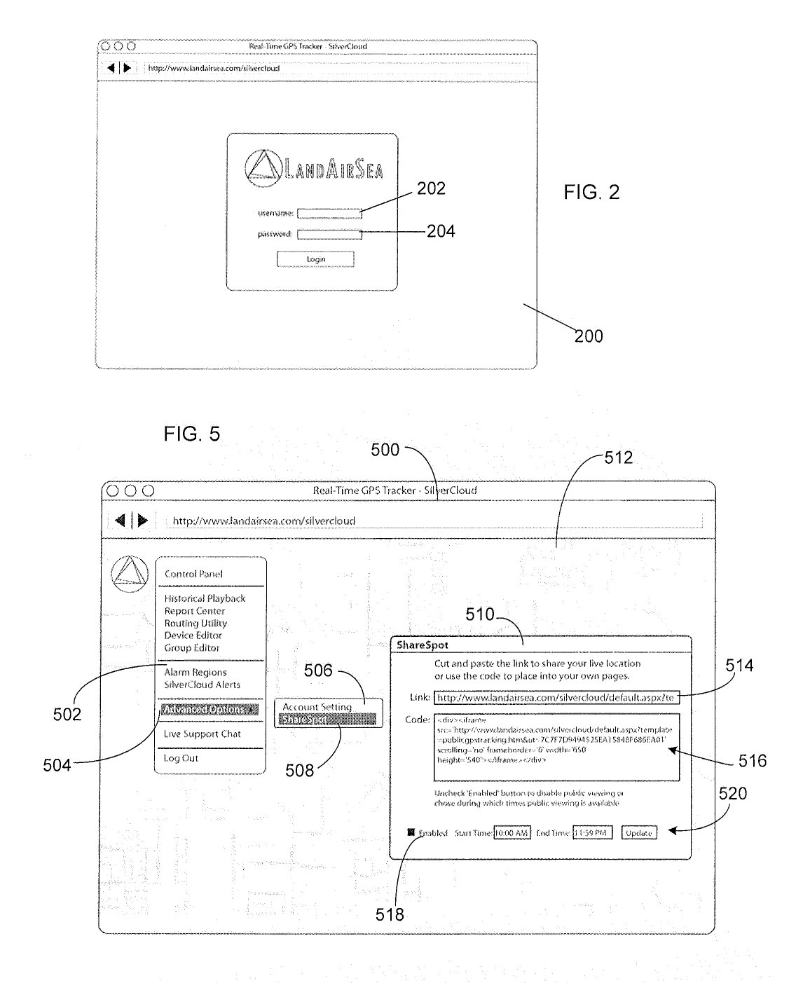

FIG. 2 is a screen shot of a web portal page 200 provided to a user by the geolocation server system of FIG. 1. The web portal page 200 may be accessed by directing a web browser on a data processing system such as authorized user device 114 (FIG. 1) connected through a network to the internet. One example of such a web portal page 200 is provided at landairsea.com. The web portal page 200 includes a text entry box 202 and password entry box 204. A user who has an account established with the operator of the geolocation server system 100 may use the web portal page 200 to enter security verification information such as a login identification and password. The authorization module 110 receives the security verification information from the user and authorizes the user to take further actions, including sharing geolocation data on remote devices.

The data retrieval server 102 is configured to receive geolocation data over a network such as the network 112 from one or mobile sources. In the exemplary embodiment, of FIG. 1, the mobile sources 122, 124, 126 provide geolocation data on a substantially real-time basis. For example, each of the mobile sources may be a self-contained location monitoring device and include a global positioning system (GPS) receiver, control processor for determining the location of the mobile source based on received GPS data from GPS satellites, a terrestrial radio transceiver for communicating with the network 112 and a battery for powering the mobile source. An example of such a mobile source is the Silver Cloud Real Time Tracking System available from Land Air Sea Systems, Woodstock, Ill. This system determines location approximately once every second and transmits its data approximately every three seconds. It includes a cellular transceiver for communicating with a cellular radio network and thereby communicating with a server system. Other examples of mobile sources include suitably equipped handheld GPS devices, mobile phones and smart phones. Any device capable of tracking an asset or individual may be the source of the data received by the geolocation server system.

As noted, the geolocation data may be received on a substantially real-time basis. By a substantially real-time basis, it is meant that the geolocation data from the mobile sources 122, 124, 126 is updated in approximately the same time during which the mobile source is active to ensure that the location provided for the mobile source by the device is very accurate at any given time, depending on conditions. For example, when a mobile source detects that it is stationary, it may reduce its update frequency or the transmission of updated information in order to conserve battery life. Under different conditions, such as moving at a high rate of speed, the device may increase its update frequency in order that its location may be tracked with high accuracy, at about the same time the device is moving. Received geolocation data from a mobile source may be stored in the database 108.

The gateway server 104 is configured to communicate with a remote map server such as map data server 120. This communication is over any suitable communications network 112 such as the internet. The map data server 120 stores map data for access over a network. The stored map data may include map information for a specified mapped area or graphical display information such as an aerial view of a mapped area. The map data may be retrieved by providing a suitable request, such as address information or GPS coordinates. An example of a map data server is the system provided by Google Maps. Those of ordinary skill in the art are familiar with the requirements of data communication with Google Maps and other map data sources.

The gateway server 104 provides the GPS coordinates received from a mobile source by the data retrieval server 102 to the map data server 120 as a request over the network 112. The request may also specify the type of graphical display information to be retrieved, such as aerial view data. In response to the request, the map data server 120 provides the specified map data over the network 112. Map data including graphical display information are stored in the database 108. The gateway server 104 also reverse-geocodes the received GPS coordinates to determine a physical address for the location of the transmitting mobile source. The physical address is stored in the database 108.

Preferably, as updated GPS coordinates or other geolocation data are received by the data retrieval server 102, they are provided to the map data server 120 and updated map data is received and combined with the updated geolocation data. In this manner a graphical display of location of the mobile source which originated the geolocation data may be updated, substantially in real-time. In this manner an icon or other representation of the mobile source may be displayed on a video display along with the map data to convey a visual understanding of the geographical location of the mobile source and produce a graphical location display. As the mobile source moves, the icon moves in relation to features of the map data such as roads and structures. If the user of the video display changes the view, such as by zooming in or zooming out or panning the view, the map data is appropriately updated and the position of the icon relative to the map data is adjusted accordingly so that the real-time geographical position is conveyed to update the graphical location display.

The user interface server 106 is configured to receive from an authorized user at the authorized user device 114 a request to share location information for a set of mobile sources such as the mobile sources 122, 124, 126. The set of mobile sources may be any number of mobile sources, from 1 to the number that are available. The request from the authorized user specifies the mobile sources to be tracked.

In response to the received request, the user interface server 106 provides at least one of a publishing code for incorporation in a destination web page and a universal resource locator (URL) for a destination web page. The destination web page is to be displayed on a display device of the authorized user or another user, such as the first user device 116 and the second user device 118. The destination web page includes a graphical location display for the set of mobile sources.

The user interface server 106 may provide a publishing code for insertion in the destination web page. The publishing code may be any code that performs the required function. One example is a Hypertext Markup Language (HTML) publishing code that is interpreted when the destination web page is rendered by the display device. An example of such a HTML publishing code is an iframe code defining an inline frame element including the map interface. The iframe code causes the map interface to be rendered with the attributes specified in the iframe code. The iframe code or other publishing code is formed by the user display interface using the geolocation data received from the set of mobile sources and the graphical display data received from the map data interface.

Additionally or alternatively, the user interface server 106 may provide a URL for a destination web page. The URL will load the destination web page on the display device and display the tracked mobile sources in conjunction with the graphical display information such as a map or aerial view. Preferably, both the publishing code and the URL are made available to the user.

Within a secure area of the geolocation server system 100, the authorized user will have the ability to generate HTML syntax to be added to a web page of choice. The following are examples of the publishing code to be made available to the authorized user.

ActiveX Control:

<OBJECT ID=“shareSpotViewer” CLASSID=“CLSIDD55D143-CBF7-11V0-8810-000000E5948C”
CODEBASE=“http://www.landairsea.com/silvercloud/sharespot.cab”><PARAM NAME=“UserToken” VALUE=“KJH5KJ66K4GKJGKHJG976”></OBJECT>

Java Applet:

<applet code=“http://www.landairsea.com/silvercloud/sharespot.class” width=“200”height=“200” userToken=“KJH5KJ66K4GKJGKHJG976”></applet>

Java Applet for Mozilla-Based Clients:

<embed code=“http://www.landairsea.com/silvercloud/sharespot.class” width=“200”height=“200” userToken=“KJH5KJ66K4GKJGKHJG976” type=“application/x-java-applet”/>

Flash Plugin:

<object data=“http://www.landairsea.com/silvercloud/sharespot.swf” width=“200”height=“200” userToken=“KJH5KJ66K4GKJGKHJG976” type=“application/x-shockwave-flash”/>

These are merely examples and can be used separately, or in conjunction with other publishing codes to deliver location data to the widest possible audience.

Once the publishing code has been added to a web page by the authorized user, visitors to that page will be able to view location data collected by the operator of the geolocation server system from the authorized user's mobile sources.

Classes exposed by the publishing code will have the following parameters and/or properties:

Login Token—an encrypted string of characters intended to hide username and password associated with the authorized user's account. This will be used by the authorized user to determine what data is being requested, and to identify the owner of the GPS device.
Client Token—after a connection is established between the geolocation server system and a user device 114, 116, 118, this will be used to identify individual requests for location data.
Aesthetic properties such as height, width, border, etc. will be accepted within the constraints set forth by the World Wide Web Consortium (W3C) and/or limitations of the client browser operating on the user device.

Classes exposed by the publishing code will automatically perform the following tasks:

Login/identification—this task will begin a session via a TCP/IP connection using standards set forth by the World Wide Web Consortium (WC3) for the individual client requesting to view the page containing the publishing code. TCP/IP standards include, but are not limited to the HTTP Protocol, FTP Protocol, and/or UDP Protocols.
Poll/Data Request—this task will request location data via a TCP/IP connection. Upon delivery of new geolocation data, sister classes within the applet, activeX or flash object will update geolocation data to be displayed within the target web page.

The publishing code and the URL both cause the browser on the display device of the user to produce a map or aerial display, or both, showing position of the set of mobile sources. In one embodiment, the position of each mobile source is shown along with text data including the physical address of the GPS device, speed and direction of motion of the GPS device, the current time, and duration at location of the GPS device. Other information may be included as well, such as identification information for the mobile source.

The authorized user at the authorized user device 114 receives the publishing code or the URL or both and may provide them to another user. The publishing code, when inserted in the other user's web page, causes the map information and geolocation information for the set of mobile sources to appear in the user's web page. One key feature is that the user who receives the publishing code or the URL from the authorized user does not need to be separately authorized to access and display the map information and geolocation information. Merely by use of the publishing code or the URL, the map information and the geolocation information are displayed.

Further, the receiving user can in turn share the publishing code and or the URL with one or more additional user. Thus, in the exemplary embodiment of FIG. 1, the authorized user at the authorized user device 114 may share the publishing code and URL with a first user who has the user device 116. The first user may in turn share the publishing code and the URL with a second user who has user device 118. In the illustrated embodiment, the user device 116 is a personal computer, such as a desktop computer or laptop computer coupled with the network 112 either by a cable or wirelessly. The user device 118 is a portable device coupled with the network wirelessly. The system and method involving the geolocation server system 100 can be extended to any type of data processing system, portable or fixed. Other examples include a fixed sign or video screen in an airport waiting area or on a display screen in an asset control center such as a switching center or command center for a fleet of vehicles.

As with the first user who received the publishing code or URL from the authorized user, the second user need not be separately authorized to access and display the map information and geolocation information. This allows the map and tracking data to be widely shared for maximum convenience. Also, no separate tracking software or applications are required on any of the user devices, including the authorized user device 114, the user device 116 and the user device 118. The only application required is a web browser or similar application which interprets and displays conventional, standardized information such as a URL and a publishing code. This maximizes flexibility in that no user will find such conventional display controlling information to be objectionable or to create a processing burden for the device, and the tracking display may be shared with the widest variety of devices.

In some embodiments, the authorized user at the authorized user device 114 may specify control inputs for controlling the display provided to other users at the user devices 116, 118. The geolocation server system 100 provides display controls to the authorized user at the authorized user device. Subsequently, the geolocation server system 100 receives display control inputs from the authorized user. The display code or URL are provided response to and in accordance with the display control inputs. In one example illustrated below in conjunction with FIG. 5, the display control inputs include an enable sharing control input and schedule defining inputs. If the enable sharing control input is activated, the authorized user may enable or disable the user to whom the publishing code or the URL are provided to share the publishing code or URL with other users. The schedule defining inputs allow the authorized user to define times of day or days of the week when the geolocation information is available. During non-scheduled times, a blank page or error message may be provided in response to the publishing code or URL.

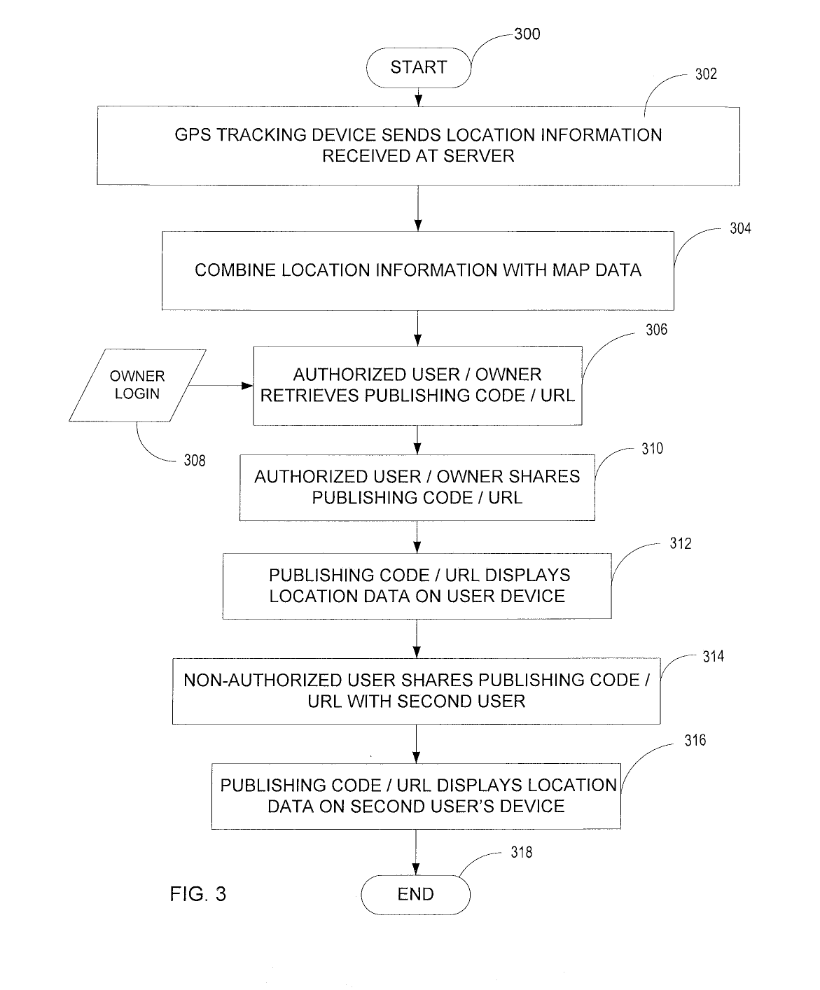

FIG. 3 is a flow diagram of a method for providing location information in accordance with one embodiment. The method begins at block 300.

At block 302, a GPS device or other mobile source sends location information to a geolocation server system. The GPS device may be any asset or person whose location is desired to be tracked. The GPS device is equipped with an apparatus such as a GPS receiver that develops location information for itself and can report that location information. The GPS device may have features that enable it to be tracked by the geolocation server system. For example, it may be assigned and communicate an identification code that must be matched at the server system, or it may encrypt its transmissions so that the geolocation server system only can correctly decrypt or decode them. The location information may be in any suitable format, such as GPS coordinates, latitude and longitude or a physical address or street address. The location information may be communicated using any suitable method such as internet protocol format conveyed over the internet and related networks. A mobile data network such as a cellular network or WiMAX network may form one or more legs of the communication network between the GPS device and the geolocation server system. The transmitted data is received at the geolocation server system and stored.

At block 304, the geolocation server system combines the received location information with map data. The map data may be generated locally from any suitable source or may be received separately from an external source over a network such as the internet. The map data may include simple two-dimensional map illustration information or aerial view information, three-dimensional views or other types of data visualization information as well.

At block 308, a user provides security verification information to the geolocation server system and logs in to the system. This may be conveniently done, for example, by the user accessing a web page over the internet and providing the necessary credentials or other information. The user providing this information may be an owner or have some other connection to the assets or persons to be tracked and have a desire to share the tracking information with one or more third parties. Also, the user providing this information may have an account or a financial relationship with the operator of the geolocation server system.

At block 306, the authorized user provides a publishing request to the geolocation server system. The geolocation server system receives the publishing request from the authorized user of the geolocation information. The request is to share information for the GPS device or other mobile source. In response, the geolocation server system provides to the authorized user a publishing code for incorporation in any web page or a URL for a web page to be displayed by the authorized user or another user. The publishing code or URL are provided in order to share with the authorized user or the other user substantially real time location for the GPS device or other mobile source.

At block 312, by instantiating the publishing code on a web page or by opening a web page designated by the URL, the location data is displayed on a user device. The device may be a device operated by the authorized user, for example, while monitoring location of the user's assets. Or, if the authorized user shares the publishing code with another non-authorized user, the non-authorized user's device will display the location data and the map for tracking location of the designated assets. The non-authorized user is one who has not provided verification information to the geolocation server system or does not have an account or other relationship with the geolocation server system. For example, the non-authorized user may be a client or customer of the authorized user. In a specific example, the authorized user has a fleet of service vehicles, each equipped with a tracking device which communicates with the geolocation server system. The authorized user has an asset tracking contract with the operator of the geolocation server system. The authorized user has available a web site with web pages describing services available. For the convenience of service customers, the authorized user includes the publishing code on one of the web pages of the web site and invites service customers to “track the progress of their service technician.” Those service customers are non-authorized users in that they don't have an account with the operator of the geolocation server system and don't have to provide login credentials to access the map data and geolocation information. The map display is automatically displayed on their user device when their browser opens the web page with the provided URL or renders the publishing code.

Similarly, at block 314, the non-authorized user can share the publishing code or URL received from the authorized user with another non-authorized user and at block 316, the location data is displayed on the second user's device. Again, the second user is not required to log in or provide authentication credentials. The method ends at block 318.

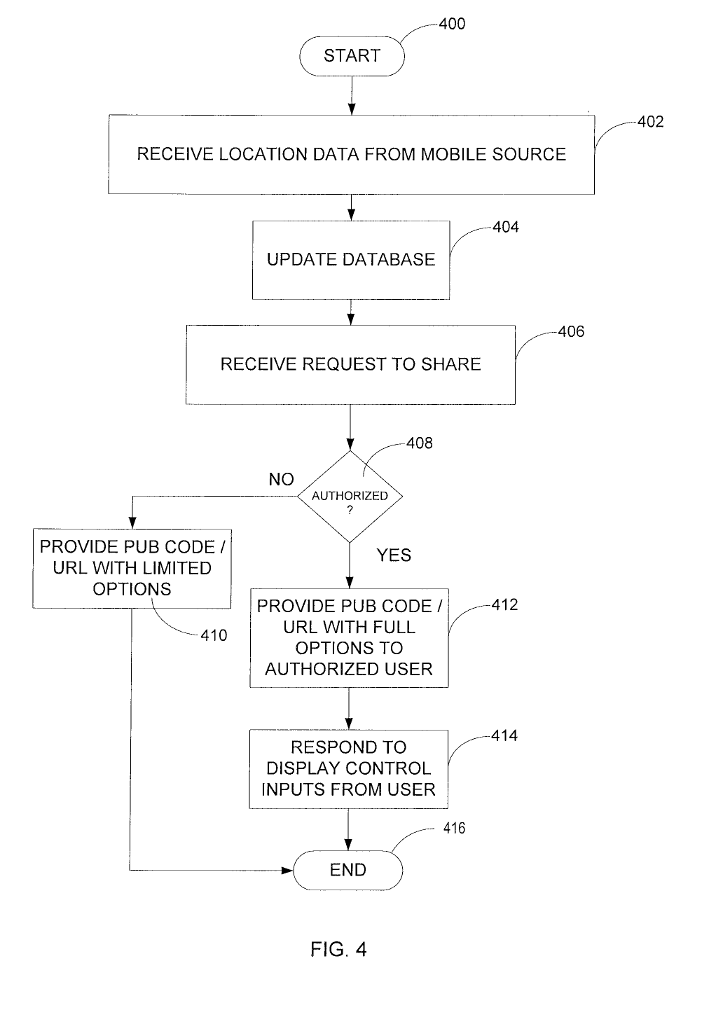

FIG. 4 is a flow diagram of a method for providing location information. The method begins at block 400.

At block 402, a geolocation server system receives location data from a mobile source that is to be tracked. The location data can be GPS coordinates or latitude and longitude information of a physical address or any other type of geolocation information for a tracked asset. At block 404, a database storing location data for the tracked asset is updated with the currently received location data.

At block 406, the geolocation server system receives a request to share the geolocation data. At block 408, the geolocation server system determines if the request was received from an authorized user. If not, at block 410 the publishing code or the URL are provided in response to the request, but they are provided with only a limited set of options. For example, they may not include the ability to control a tracking schedule or to enable a recipient to share with other users.

If the request is received from an authorized user, at block 410, the publishing code or URL are provided to the authorized user with full options, including the ability to enable or disable sharing and to set a schedule when tracking is available. At block 414, if the authorized user has provided display control inputs such as activating the display schedule or disabling sharing of the tracking data, the geolocation server system responds to those inputs. The method ends at block 416.

FIG. 5 is a screen shot illustrating an exemplary web page 500 provided to an authorized user after login access to the geolocation server system FIG. 1. The web page 500 of FIG. 5 illustrates what the owner or authorized user would see after providing login access credentials to the geolocation server system to obtain validation. The web page 500 includes a control menu 502. The control menu 502 has several control options that may be selected by activation of the user interface of the authorized user device on which the web page 500 is displayed. For example, a mouse may be used to select and click an option such as the option 504 labelled Advanced Options. In the example of FIG. 5, activating option 504 calls a popup menu 506 with options including an option 508. Activating the option 508 calls a geolocation menu 510. Map data and graphics 512 are displayed on the web page 500. The map data include shapes defining streets, buildings and other structures and may be two-dimensional graphics or aerial view data. Menus when called are displayed in the foreground above the map data and graphics.

After security verification, the authorized user receives full access to all GPS tracking system options using control menu 502. From the control menu 502, the owner or authorized user can view real-time tracking location data such as speed, address, direction, time and duration for a mobile source or tracked asset. Geolocation data is received and updated substantially in real time in the geolocation server system. The display is similarly updated substantially in real time. The web page 500 serves as a user interface for the authorized user to access the geolocation server system.

The geolocation menu 510 allows the authorized user to retrieve the provided publishing code or URL to share the location of a mobile source. The geolocation menu contains both the URL 514 and the publishing code 516. Either the URL 514 or the publishing code 516 may be copied and pasted by the authorized user or another user into a webpage or web browser address bar. In the illustrated example, the publishing code is HTML code and more specifically is an iFrame code for placing an inline frame in a web page. However, in other systems, other suitable publishing codes may be used to provide similar functionality.

Additionally, the geolocation menu 510 provides display controls to the authorized user. The display controls in this example include an enable sharing control input 518 and schedule defining inputs 520. The enable sharing control input 518 allows the user to the owner may choose to disable or enable public viewing of the location. When the check box of the enable sharing control input 518 is selected, the geolocation data and map data defined by the URL 514 and publishing code 516 will be displayable. The schedule defining inputs 520 allow the authorized user to set desirable hours when the geolocation data and map data defined by the URL 514 and publishing code 516 will be displayable.

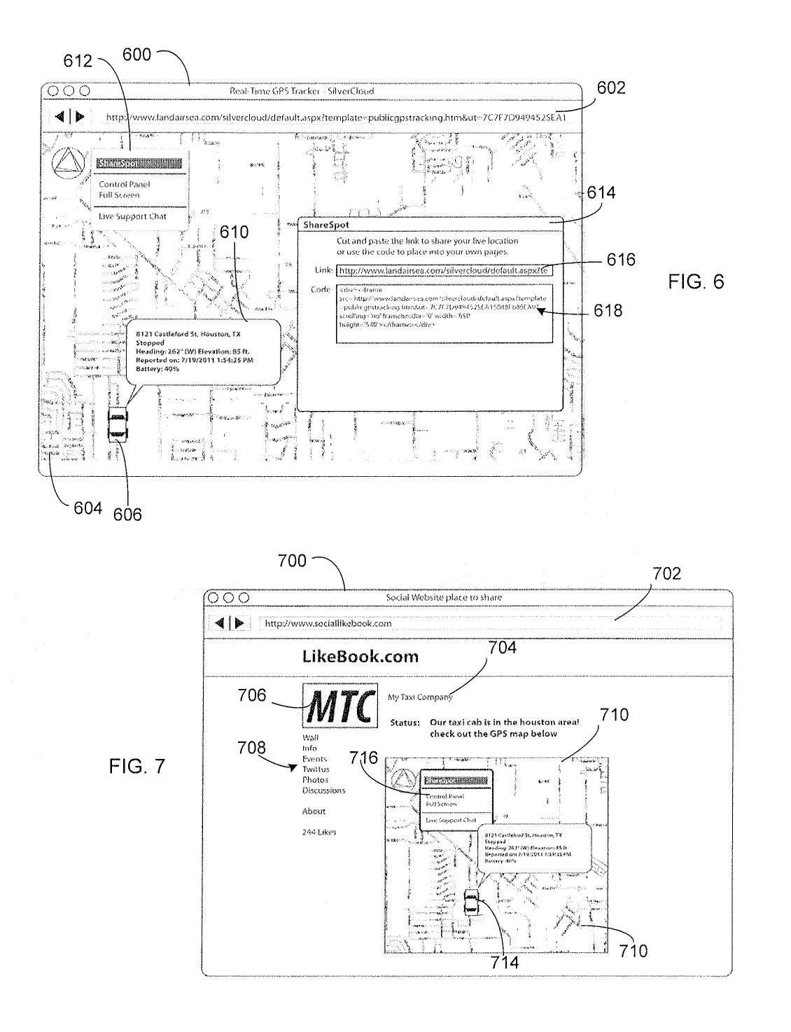

FIG. 6 is a screen shot illustrating an exemplary web page 600 provided to a non-authorized user by the geolocation server system of FIG. 1. The web page 600 includes an address bar 602, map data 604 and a display of a tracked mobile source 606 shown in conjunction with the map data 604 and current status information for the tracked mobile source 606. In the illustrated embodiment, the status information includes real-time tracking location data such as speed, address, direction, time and duration for the tracked mobile source. Other information may be provided as well. As updated geolocation data are received from the tracked mobile source 606, its position relative to the map data 604 is also updated so that over time, the graphic image of the mobile source 606 appears to move across the map on the web page 600.

The address bar 602 displays the URL provided to the user of the web page by an authorized user or by a non-authorized user. The URL when placed in the address bar 602 after receipt by the user from the owner will load the web page 600 displaying the location of the GPS tracking device or other mobile source without the need for security verification. Unlike the owner, the non-authorized user is not required to enter account identification and password to view the geolocation data.

The web page 600 opened by the user with the URL further includes a control menu 612. Compare to the control menu 502 (FIG. 5) displayed to the authorized user, the control menu 612 provided to the non-authorized user has fewer control options. However, activating a first option on the control menu 612 causes a geolocation menu 614 to be displayed. The geolocation menu 614 displayed to the non-authorized user allows the non-authorized user to retrieve the provided publishing code or URL to share the location of a mobile source. The geolocation menu contains both the URL 614 and the publishing code 616. Either the URL 614 or the publishing code 616 may be copied and pasted by the non-authorized user into a webpage or web browser address bar 602. However, unlike the web page 500 provided to the authorized user (FIG. 5) which includes display controls including an enable sharing control input 518 and schedule defining inputs 520, such controls are absent from the web page 600 provided to the non-authorized user. Thus, the non-authorized user has limited options provided by the control menu 612 but is still able to share the location of the tracked GPS device or mobile source with others. The user can share the location via URL 616 or embed the publishing code 618 into another webpage. However, the user cannot disable or enable the availability of the GPS tracking device location sharing without the need for security verification.

FIG. 7 is a screen shot of an exemplary web page 700 illustrating embedding of a publishing code in the web page 700 for use by a user. The web page 700 is for a business which makes use of the services of the geolocation server system. The web page 700 has an address bar 702 that indicates it is associated with the web site sociallikebook.com. The web page 700 includes text 704, graphic elements 706 and hyperlinks 708 of the web site. Further, the web page 700 includes a portal 710 which displays map data 712 and a display of a tracked mobile source 714 shown in conjunction with the map data 712 and current status information for the tracked mobile source 716. The portal 710 in one example is formed in the web page 700 using an HTML inline frame or iFrame.

Moreover, the portal 710 includes a control menu 716. Activating a first option on the control menu 716 causes a geolocation menu similar to the geolocation menu 614 of FIG. 6 to be displayed. The geolocation menu is not shown in FIG. 7 so as to not unduly complicate the drawing figure. The geolocation menu displayed to the non-authorized user allows the non-authorized user to retrieve the provided publishing code or URL to share the location of a mobile source. Either the URL or the publishing code may be copied and pasted by the non-authorized user into a webpage or web browser address bar. However, unlike the web page 500 provided to the authorized user (FIG. 5) which includes display controls including an enable sharing control input 518 and schedule defining inputs 520, such controls are absent from the portal 710 provided to the non-authorized user.

The publishing code can be embedded into any website and does not require any installation of files or databases on the website's server. The publishing code will generate portal 710 that will allow any user to view the location of the GPS tracking device. This portal 710 can be viewed using both computer web browsers and mobile device web browsers. The user also has limited options but retains the ability to share the location via publishing embed code or URL.

In accordance with a particular embodiment, when map data is requested from the map data server, a standard retrieving URL is used. This is true for requests that originate within the geolocation server system itself or for requests for map data that originate outside the geolocation server system but originate on a web page which employs the URL or publishing code provided by the geolocation server system.

For example, when the geolocation server system is receiving updated geolocation data from a tracked mobile source, if the source is moving, the geolocation server system may need to retrieve additional map data from the remote map data server, such as data for an adjacent map panel when the tracked mobile source has moved off the edge of the current map data. When the request is submitted from the geolocation server system to the map data server, a standard retrieving URL or root URL is used. Thus, in the examples of FIGS. 5 and 6, the standard URL landairsea.com/silvercloud is used. Other additional address information may be appended to the standard URL, but the root URL remains the same.

Similarly, when requests for additional map data are submitted from a user's web page, the same standard retrieving URL is used. In the example of FIG. 6, a user may use the interface to move the displayed portion of the map. This may occur by panning across the screen or by zooming in or out. Any variation like this may generate a request to the map data server for additional map data. In accordance with this embodiment, the same standard retrieving URL is used for the request, in this example, landairsea.com/silvercloud. Again, other address data may be appended to the standard root URL, but the same root URL is used.

Similarly, when requests for additional map data are submitted from a portal that is generated using a publishing code, the same standard retrieving URL is used. In the example of FIG. 7, a user may use the portal to move the displayed portion of the map, such as by zooming or panning. Such a variation generates a request to the map data server for additional map data. For each request, the same standard retrieving URL is used for each request, again in this example, landairsea.com/silvercloud.

Many benefits accrue from this strategy of using a standard URL or root URL. For example, operation may be more uniform when map data requests originate from a single address than if a variety of URL addresses are used. Some URLs may not be fully and reliably maintained, leading to inconsistent results. Operators of commercial map databases may count the number of referrals to a URL when assessing the relative popularity of a URL or web site. By using a common URL, the count is necessarily increased at the map data server so that all referrals are attributed to the standard retrieving URL when the map data server assesses the popularity of referring web sites. Popularity can be an important factor in how online requests are handled. For example, popularity is one factor in how prominently in a search result list a web site is displayed, or how prominently a banner ad is displayed. More prominent display can in turn lead to more referrals and increased popularity. For the operator of the geolocation server system, the strategy of using a common or standard referring URL can drive more online traffic to the geolocation server system and associated web site, increase sales and profits and permit more reliable map data and tracking data to be provided to users accessing the server system.

While a particular embodiment of the present invention has been shown and described, modifications may be made. For example, while HTML publishing code and URLs have been shown in the examples, it will be readily understood that any type of data linking technology that properly causes location data and map data to be combined and provided to a user may be substituted. It is therefore in the appended claims to cover all such changes and modifications which fall within the true spirit and scope of the invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for providing location information, the method comprising:
at a server system, periodically receiving geolocation data for a mobile source;
storing the geolocation data in a database;
at the server system, receiving a publishing request from an authorized user of the geolocation data to share location information for the mobile source; and
in response to the publishing request, communicating to the authorized user one or more of
a publishing code for incorporation in any web page, or
a Universal Resource Locator (URL) for a web page to be displayed by the authorized user or another user in order to share with the authorized user or other user substantially real time location for the mobile source.

2. The method of claim 1 further comprising:
receiving a request including the publishing code or the URL from a non-verified user; and
in response to the request, communicating from the server system a web page displaying location of the mobile source on a graphical location display.

3. The method of claim 1 further comprising:
at the server system, receiving security verification information from a user; and
based on the security verification information, authorizing the user to share the geolocation data on remote user devices.

4. The method of claim 3 further comprising:
at the server system, providing display controls to the authorized user at a remote processor;
receiving display control inputs from the authorized user at the remote processor;
in response to a web page request for the web page incorporating the publishing code or URL, providing the requested web page to one or more remote user devices in accordance with the display control inputs.

5. The method of claim 4 wherein receiving display control inputs comprises receiving at least one of:
an enable sharing control input; and
schedule defining inputs.

6. The method of claim 1 wherein communicating the publishing code comprises:
communicating Hypertext Markup Language (HTML) iframe code defining an inline frame element for insertion in the any web page, the web page displayable on any public internet media outlet.

7. The method of claim 1 further comprising:
receiving a second publishing request from a non-verified user; and
in response, communicating the publishing code or URL for incorporation in a web page specified by the non-verified user.

8. The method of claim 1 further comprising:
combining the geolocation data with graphical display information to produce a graphical display of location of the mobile source in a surrounding geographical area; and
updating the graphical display of location of the mobile source upon receipt of additional geolocation data for the mobile source.

9. The method of claim 8 wherein combining the geolocation data with graphical display information comprises combining the geolocation data with map data for the surrounding geographical area to show the location of the mobile source on a map.

10. The method of claim 8 wherein combining the geolocation data with graphical display information comprises combining the geolocation data with aerial view information to show the location of the mobile source on an aerial view of the surrounding area.

11. The method of claim 8 further comprising:
retrieving the graphical display information from a remote map data server for combination with the geolocation data.

12. The method of claim 11 wherein receiving geolocation data comprises receiving Global Positioning System latitude and longitude data derived by the mobile source to identify location of the mobile source and wherein retrieving the graphical display information comprises:
at the server system, formatting a request to the remote map data server, the request including latitude and longitude parameters based on the geolocation data and a standard retrieving URL for counting referrals from the retrieving URL to the remote map data server;
communicating the request from the server system to the remote map data server to retrieve the graphical display information corresponding to the latitude and longitude parameters from the remote map data server and to count the referral from the retrieving URL; and
receiving the graphical display information from the remote map data server.

13. A geolocation server system comprising:
a data retrieval server configured to receive geolocation data over a network from one or more mobile sources;
a gateway server configured to communicate with a remote map data server;
a database configured to store data including the received geolocation data and map data received from the map data server; and
a user interface server configured to receive from an authorized user a request to share location information for a set of mobile sources of the one or more mobile sources, and, in response to the request, to provide at least one of a publishing code for incorporation in a destination web page, and a Universal Resource Locator (URL) for the destination web page,
the destination web page to be displayed on a display device of the authorized user or another user and to include a graphical location display for the set of mobile sources.

14. The geolocation server system of claim 13 further comprising an authorization module configured to receive identification data from a user and to designate the user as an authorized user based on the received identification data.

15. The geolocation server system of claim 13 wherein the gateway server is further configured to determine a physical address corresponding to the received geolocation data and combine the physical address with the received map data on a map interface, the publishing code and the URL identifying the map interface.

16. The geolocation server system of claim 15 wherein the user interface server is configured to respond to the request by providing Hypertext Markup Language (HTML) iframe code defining an inline frame element including the map interface to be inserted in the destination web page.

17. The geolocation server system of claim 15 wherein the user interface server is configured to respond to the request by providing a URL that specifies where the map interface to be inserted in the destination web page is available for retrieval.

18. The geolocation server system of claim 13 wherein the publishing code comprises Hypertext Markup Language (HTML) publishing code.

19. A global positioning system (GPS) tracking method comprising:
receiving at a data retrieval server GPS location data from a GPS device;
at a gateway server in data communication with the data retrieval server, determining a physical address of the GPS device;
storing the physical location at a database associated with the gateway server;
at the web server, publishing the location data on a map interface;
receiving an access inquiry from an authorized user;
in response to a user request, providing to the authorized user one or both of a public portal publishing code to insert on a web page designated by the authorized user, or
a Uniform Resource Locator (URL) to share with a web browser; and
in response to parameters of the public portal publishing code or the URL, providing the location data on the map interface to be inserted in the web page or to be shared to the web browser.

20. The GPS tracking method of claim 19 wherein publishing the location data on a map interface comprises:
combining a graphical image for the GPS device with location graphic data and text data including:
the physical address of the GPS device,
speed and direction of motion of the GPS device,
current time, and
duration at location of the GPS device.

21. The GPS tracking method of claim 19 further comprising:
at the gateway server, formatting a request to a remote map data server, the request including
geographical parameters based on the GPS location data from the GPS device, and
a standard retrieving URL for counting referrals to the remote map data server so that all referrals are attributed to the standard retrieving URL when the map data server assesses popularity of referring web sites;
communicating the request from the server system to the remote map data server to retrieve the graphical display information corresponding to the latitude and longitude parameters from the remote map data server and to count the referral from the retrieving URL; and
receiving the graphical display information from the remote map data server.
